(19) United States
(12) Patent Application Publication
(10) Pub. No.: US 2021/0310269 A1
(43) Pub. Date: Oct. 7, 2021

(54) Outdoor Flag Holder with Lighting

(71) Applicant: Richard Dinse, Oceanside, CA (US)

(72) Inventor: Richard Dinse, Oceanside, CA (US)

(21) Appl. No.: 17/301,265

(22) Filed: Mar. 30, 2021

Related U.S. Application Data
(60) Provisional application No. 63/004,227, filed on Apr. 2, 2020.

(51) Int. Cl. E04H 12/22; B65D 43/16; B65D 51/24; B65D 25/04; B65D 43/22; B65D 25/10; F21V 33/00; F21V 23/04

(52) U.S. Cl. CPC E04H 12/2238; B65D 43/166; B65D 51/242; B65D 25/04; A45B 23/00; B65D 25/108; F21V 33/00; F21V 23/0464; F16M 2200/08; B65D 43/22

(57) ABSTRACT

A case for a flag that opens to form a base for the flag. The case is for an indoor/outdoor lighted stand in a box-like configuration that when opened provides a surface to securely hold poles that are two inches in diameter or smaller and twelve feet or less in overall height.

This application claims priority from 63/004,227, filed Apr. 2, 2020, the entire contents of which are herewith incorporated by reference.

### BACKGROUND

Flag holding assemblies can be different sizes, weights and configurations. Such assemblies have conventionally been difficult to pick-up, transport, and store. As of this writing there is not any portable flag stand in the marketplace designated for use as strictly a portable outdoor flag stand.

### SUMMARY

The inventor recognized the need for a transportable device that can hold and also display, a utility element such as a flag or umbrella.

Embodiments include an internally solar powered stand to support flag and umbrella poles of various sizes, two inches in diameter and smaller, that is easy to carry, transport, store and utilize both indoor and outdoors.

The present application describes a flag holder device that can be used and stored indoors or outdoors. The device folds into a box with storage compartments for the flag and flag accessories. The box opens to form a base which includes lights and also includes a holder for the flag parts. The open base forms an integrated weighted system with weights that are distributed over most of the surface of the base. The weights used are effective to adequately weight the stand for stabilizing it

during windy conditions and also to securely hold the pole upright with the attached flag or umbrella,

The present application describes a portable device, in the form of a box, with a recessed carrying handle on the top of the box. The interior of the box contains a series of lights, e.g., solar powered lights, a hollow steel sleeve (e.g, nine inch tall) capable of accommodating various size poles with a diameter of two inches and smaller, and two holding compartments. When the box is opened, the two hinged halves provide a flat rectangular or square surface of adequate size to form a weighted base.

The open box is sufficiently weighted to secure the stand holding the pole containing the flag or umbrella during windy or inclement weather conditions.

### BRIEF DESCRIPTION OF THE DRAWINGS

Aspects of the invention are shown in the accompanying drawings, wherein:

FIG. 1 shows the carrying case in a closed condition;

FIG. 2 shows the carrying case in the open position, showing the weights extending over most of the area of the carrying case;

FIG. 3 illustrates how the sleeve (e.g., 9 inch sleeve) is placed into the carrying case;

FIG. 4 shows how the pole with the attached flag is inserted into the sleeve to be displayed;

FIG. 5 shows the operation of the lighting system;

FIG. 6 shows an embodiment where the case holds an umbrella;

FIG. 7 illustrates an exploded view of the parts of the case; and

FIG. 8 shows an exemplary lens insert used for the lighting system.

### DETAILED DESCRIPTION

The present application is intended to be used as a stand for an upright utility element that is held on a pole, such as a flag or an umbrella. An embodiment is for a flag holder, which is described herein, however, other things on poles, including umbrellas, are contemplated.

Aspects are described in the attached.

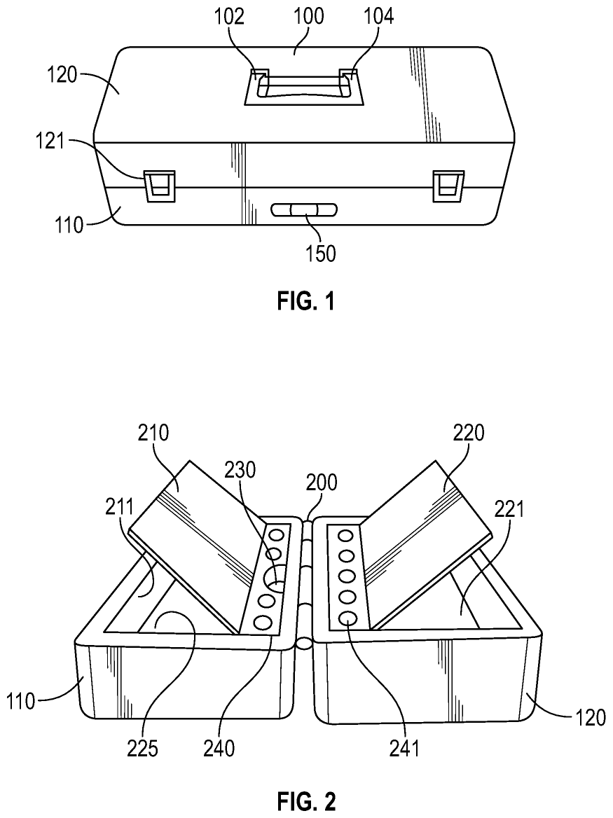

FIG. 1 illustrates the closed box 100, showing the way that the box is closed and configured for transportation. The box includes a handle 102 which is recessed within a recess 104 in the top of the box.

The case has two hinged portions 110 and 120 which are hinged together by a hinge shown in FIG. 2 as 200. This hinge 200 can be a planar piano style hinge. The two box portions have identical perimeter sizes, so that when they fold together using the hinge 200, the two sides perfectly mate, to form a closed surface. When closed, the interior of the box is protected from the elements and can be tightly secured by the two metal hinges on the front of the box.

When opened, each portion of the box 110, 120, forms an open compartment. Thus, the box portions can close as shown in FIG. 1, for transportation, and can open as shown in FIG. 2 to provide a square or rectangular base to 1) allow access to the contents of the compartments, and 2) form a support as described in further detail herein.

The support, as described herein, is intended to support an upright pole, holding a utility item, such as flag or umbrella. The base also works better to contain the flag when level, and hence an embodiment includes a bubble level 150 on its outer surface to facilitate locating the box in a place where it can best operate as a support.

FIG. 2 shows how the two portions 110, 120 of the box can be opened. Once opened, there are metal plates 210, 220 covering each compartment. The plates provide ballast for the support of the pole and utility item held by the pole. It is preferable that the metal plates distribute their weight over most of the area of the open rectangular boxes. In one embodiment, as shown in FIG. 2, the metal plates 210, 220, completely cover the compartments other than the areas for the lighting, and the area for the hole for the stand. In embodiments, the metal plates cover at least 80% of the area exposed by the open box.

Moreover, most transportation boxes are intended to be as light as possible. This transportation box, however, is intended to provide ballast, and therefore is intentionally heavy. Unlike most transportation boxes of this type, there is an intentionally heavy ballast item being held in the box. This hence goes against the established teaching of minimizing weight of this type, by instead maximizing the weight and distributing that weight over a maximum area of the open box.

In a first embodiment, the weight is formed from a first plate 210 covering the compartment 225 on the inside of portion 110 and a second plate 220 covering the compartment 221 on the inside of the portion 120. The insides 221, 225 of the compartments can hold the different parts described herein. In embodiments, the weights can fit against recesses, for example the weight 210 is held by recesses such as 211 on the inside of the box to be held on the top of the box.

The metal plates as described herein can serve as weights for ballast when the device is being used as a stand. In one embodiment, the metal plates 210, 220 are 6 to 12 pounds each, having their weight extending along most of the area e.g. more than 80% of the area, of the opened transportation box.

In another embodiment, shown in more detail in FIG. 7, the metal plates 210, 220 are hinged on the compartment, and there are additional plates 802, 804 that are 6-12 pounds each, and act as weight plates for ballast on the stand that holds the flag. This alternative embodiment may have the advantage that the metal plates 802,804 can be removed to facilitate transportation in a situation where the open box will not be used as a base.

When the transportation box is open, there is also an open surface that includes a hole 230, FIG. 2, which is formed in the top surface. Two rows of solar lights 240, 241 enable shining light upwards towards the item being held by the pole, for example a flag or an umbrella. In this embodiment, the solar lights include solar cells and a battery that holds the charge from the solar cells.

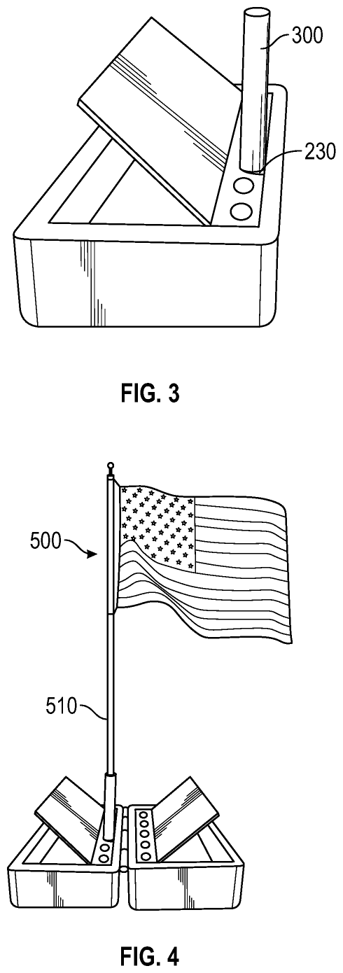

In operation, one of the parts of the kit is a hollow metal sleeve shown as 300 in FIG. 3. The sleeve is inserted in the hole 230 in the case and acts to supports and holds the utility pole 500, 510.

In one embodiment, this can be a 9 inch hollow sleeve.

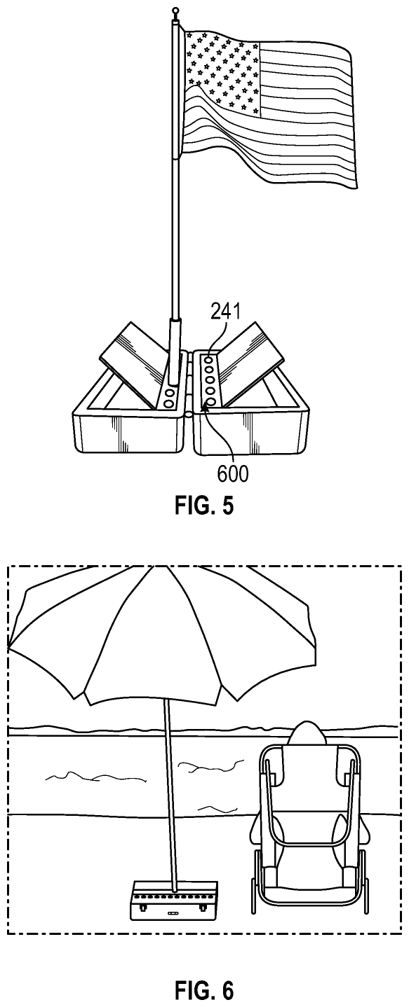

Other pole parts fit into the hollow sleeve, for example FIG. 4 shows how the pole part 510 fits into the hollow sleeve, and another pole part 500 fits into the pole part 510. Any number of these pole parts can be held together to containing various size smaller inserts such as 300 in FIGS. 3 and 4 to hold the pole 510, shown in FIG. 5.

FIG. 5 illustrates how the pole with a flag or umbrella attached fits into the sleeve, where the outer surfaces of the flag pole 510 fits tightly within the inner surfaces of the sleeve. The sleeve contains two threaded metal screws, that when tightened, firmly secure the pole inserted into the sleeve in an upright position. In one embodiment, the pole 510 is a seperable pole, with multiple parts 500, 510.

Solar lights 240, 241 are also provided that shine light upwards toward the flag, to illuminate the flag 500. Alternately, these can be LED lights that are battery operated.

There can also be a light sensor 600, which detects low light conditions. When the low light conditions are detected, and the box is open, the solar lights 240, 241 are automatically illuminated to shine upwards into and illuminate the flag 500.

The inventor recognizes that a system such as this requires 23-25 pounds of weight in order to hold the case stable on the ground. Accordingly, each of the covers 200, 220 is preferably around 10 pounds of steel weight distributed over the maximum area of the box, to provide traction and ballast to the box.

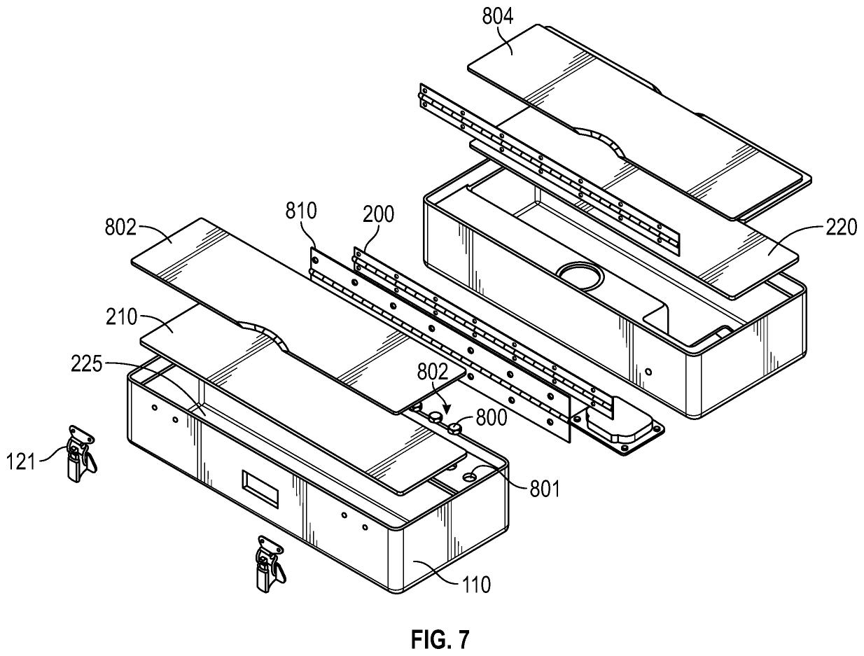

The above has described holding a flag as the utility item; however, the device can alternatively be used to hold an umbrella as shown in FIG. 6.

The specific parts can be made in many different ways.

FIG. 7 illustrates an exploded section showing the different parts as connected together. The first portion 110 is shown hinged via the hinge 200 to the second portion 120. Each portion such as 110 has a cover 210, which is hinged to the body of the case by hinge 810. The covers 210, 220 are covered by additional weight plates, shown generally as 800, 802. The user can remove these weight plates and pivot the covers on the hinges, to obtain access to the interior compartment such as 225. 225 holds the sleeve 300, as well as the different parts of an exploded or collapsible flagpole 510, or flag pole accessories.

FIG. 7 also shows how the solar lights such as 800 can be located with lens inserts 802 at the area between the two portions.

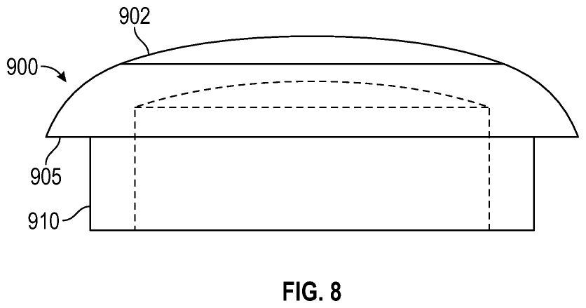

FIG. 8, illustrates more details of the lens assembly 900 which can snap into or otherwise fit into, a hole 801 in the case. The lens 900 has a rounded top 902 that has a lip 905 forming a flat surface which presses against the top surface of the case. The reduced diameter section 910 fits inside the hole in the case.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Different options can include:

A colored lens for the solar lights;

Industrial grade latches to secure both sides of the box when in the open position

Plug or battery pack to jump start and power up the solar lights if no sun is available to provide the energy the device can also include the following items.

Recessed grip handles on both sides of the box to make it easy to pick up the box should the handle on top of the box be broken.

Recommended powder coating as that finish is superior to paint.

Recommended using building materials that were not subject to rust or corrosion. Also, using industrial grade riveted latches and hinges. Specifically called out stainless steel.

Box to contain an electrical receptacle in order to quick charge the solar lights should weather conditions prevent charging from the sun.

Advantages can include the following:

1. There is not a like product of this configuration containing built-in solar lights, being manufactured and offered nationally or internationally

2. It's an easy to use, all-in-one device. Easy to handle, easy to transport and easy to store in the trunk of your car, truck or garage

3. Product can be used indoor as well as outdoor

4. Designed for any pole that has a diameter of 2 inches or less

5. Designed to withstand outdoor weather conditions; wind, rain and snow

6. Box contains a recessed bubble level to easily determine if the stand is sitting level and provides confirmation that the pole is upright

7. The sturdy handle for easily carrying the box is recessed into the top of the box

8. The steel sleeve that holds the pole is outfitted with two threaded knobs that adjust to safely secure any size pole 2 inches or less in diameter

9. Industrial grade steel latches on the front of the box safely secure the box for transporting

10. Drain holes are provided on the base of the box to allow for water drainage from compartments 211 and 221.

11. Solar panels are located inside the box to protect them from accidental damage and allows the lights to be charged when the box is open and in-use

12. Solar lights sufficiently bright enough to adequately illuminate the flag or umbrella during low-light conditions

13. Portable stand is not subject to rust or corrosion.

What is claimed is:

1. A pole holding device, comprising:
a folding box, having first and second parts that fold together to close, and also fold apart to open,
the first and second parts having the same perimeter sizes,
a hinge, hinging together the first and second parts,
where the first and second parts of the box form compartments with open portions therein;
a pole holding surface, formed in an inside of the folding box, and exposed when the box is unfolded, the pole holding surface being sized to have an inner surface;
a first pole piece, having an outer surface that fits within the inner surface of the pole holding surface, the first pole piece fitting inside the compartments;
plural additional pole pieces, each having a size to fit inside the compartments, one of the pole pieces fitting inside inner surfaces of the first pole piece, other pole pieces attaching to the one piece; and
ballast forming plates, fitting inside the folding box, and covering at least 80% of an open area of the folding box when the box is open, the ballast forming plates providing ballast to hold the pole, when the pole is holding a utility item at its distal end.

2. The device as in claim 1, wherein the utility item is a flag.

43. The device as in claim 1, wherein the utility item is an umbrella.

4. The device as in claim 1, wherein the ballast forming plates are formed of metal and weigh at least 20 pounds.

5. The device as in claim 1, wherein the ballast forming plates are attached to an inside surface of the folding box by hinges.

6. The device as in claim 1, wherein the ballast forming plates are removable from the inside surface of the folding box.

7. The device as in claim 6, wherein further comprising hinging covers over the compartments, and where the ballast forming plates fit over the hinging covers.

8. The device as in claim 1, further comprising a level, on the closable box.

9. The device as in claim 1, wherein the ballast forming plates collectively comprise 20 pounds of weight, distributed over at least 80% of the surface of the open box, when the box is opened.

10. The device as in claim 1, further comprising integrated lighting, inside the box, facing towards the utility item.

11. The device as in claim 10, further comprising a light sensor, and wherein the integrated lighting automatically lights up when the box is open and the light sensor detects darkness.

12. The device as in claim 10, further comprising lens assemblies, which fit into holes in that are facing towards the top when the box is open.
